(19) United States
(12) Patent Application Publication
(10) Pub. No.: US 2024/0232791 A1
(43) Pub. Date: Jul. 11, 2024

(54) ADDRESS TRANSLATION FOR NON-STANDARD LOCATIONS

(71) Applicant: Todd Waldemar, Portsmouth, VA (US)

(72) Inventor: Todd Waldemar, Portsmouth, VA (US)

(21) Appl. No.: 18/615,968

(22) Filed: Mar. 25, 2024

Related U.S. Application Data
(60) Provisional application No. 63/345,163, filed on May 24, 2022.

(51) Int. Cl. G06Q 10/0833; H04W 4/029

(52) U.S. Cl. CPC G06Q 10/0833; H04W 4/029

(57) ABSTRACT

The present method and system provides for supplementing a commercial transaction, including providing location data to a commercial transaction system, the location data including location input data and location output data for use by the commercial transaction system. The method and system includes receiving a location identifier from the commercial transaction system, the location identifier indicating a non-postal address identified by a user input into the commercial transaction system based at least on the location input data and the location output data. Therein, the method and system includes presenting the location identifier to a location translation system and receiving a geolocation identifier in response thereto, the geolocation identifier identifying a global positioning location associated with the location identifier. The method and system therein submits submitting the geolocation identifier to the commercial transaction system or in another embodiment to a delivery computing system.

### RELATED APPLICATIONS

The present application is a non-provisional application of and claims priority to U.S. Provisional Patent Application Serial No. 63/345,163 entitled “ADDRESS TRANSLATION FOR NON-STANDARD LOCATIONS” filed Mar. 23, 2023.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The disclosed technology relates generally to an addressing system and more specifically to a system and method for translating non-standard locations for an addressing system.

### BACKGROUND

Many physical locations have non-traditional addresses, where a non-traditional address is an address not generally recognized by standard addressing systems. By way of example, a military base has barracks or quarters with addressing known to the military base, but not generally recognizable or usable within third-party or commercial addressing systems.

Having a non-traditional address creates numerous problems for delivery and/or other services that rely on standard commercial addressing systems. The residents are unable to partake in various delivery services, including for example food delivery services, grocery delivery services, package delivery services, etc.

When residents do use these commercial systems, the delivery drivers are often confounded, wasting time and typically unable to find the correct building and/or unit.

There are several current solutions, all lacking in specificity to solve this current problem. One solution is adding a GPS location factor to an online order. This is also known as “dropping a pin.” This requires the user to be manually in place to select the location identifier, as well as requiring the delivery person to receive and integrate the GPS location as part of the delivery process. The GPS location does not include driving directions and many GPS location identifiers can be inaccurate to provide improper delivery addresses. Thus, delivery drivers are just as likely to arrive at the wrong location.

Another current solution is generating a designated drop off location and contacting the recipient while approaching delivery drop-off. This requires coordination between the delivery driver and recipient, which if the driver is delayed the recipient can waste time waiting. For general commercial carriers, e.g. UPS, Fed-Ex, DHL, etc., this solution is not a viable option. This solution also fails to allow for delivery to a recipient's door, and thus is not a viable solution for time-sensitive deliveries, for example food or beverages.

As such, there exists a need for a computer processing method and system that supplements commercial transactions by accounting for nonconforming or non-standard address or location information.

### BRIEF DESCRIPTION

The present method and system provides for supplementing a commercial transaction, including providing location data to a commercial transaction system. The location data includes location input data and location output data for use by the commercial transaction system. The method and system includes receiving a location identifier from the commercial transaction system, the location identifier indicating a non-postal address identified by a user input into the commercial transaction system based at least on the location input data and the location output data. Therein, the method and system includes presenting the location identifier to a location translation system and receiving a geolocation identifier in response thereto, the geolocation identifier identifying a global positioning location associated with the location identifier. The method and system therein submits the geolocation identifier to the commercial transaction system or in another embodiment to a delivery computing system.

In one embodiment, the geolocation identifier includes a latitudinal value and a longitudinal value. The geolocation identifier may further include text-based location instructions, for example noting landmarks or other identifiers. The geolocation identifier may further include visual data, for example one or more images of the location or similar visual or graphical data.

The non-postal address may be a physical location not categorized by an address management system. For example, the address management system may be data as managed by the United States Postal Service (USPS).

The non-postal address may be a physical location disposed on a general location or facility that falls outside of the address management system. For example, this can include one or more facilities managed by the United States Department of Defense (DOD), other government entity, a non-government entity, or any other suitable entity or entities. For example, the physical location may be disposed on a military installation or base managed by the DOD. For example, one location may be a barrack used to house military personal. The non-postal address can also identify a particular room within the barrack.

The geolocation identifier is then usable by the commercial transaction system and/or the delivery computing system for facilitating delivery of item(s) acquired as part of the commercial transaction. For example, if a soldier living on in a military barrack orders food from an establishment, the geolocation identifier is usable to supplement the delivery instructions allowing for a delivery driver to find the non-postal address.

### BRIEF DESCRIPTION OF THE DRAWINGS

FIG. 1 illustrates one embodiment of a processing system using the address translation system;

FIG. 2 illustrates one embodiment of a commercial transaction system;

FIG. 3 illustrates one embodiment of the address translation system;

FIGS. 4-6 illustrate sample screenshots of the user input functions as part of the commercial transaction system; and

FIG. 7 illustrates a flowchart of the steps of one embodiment for supplementing a commercial transaction.

A better understanding of the disclosed technology will be obtained from the following detailed description of the preferred embodiments taken in conjunction with the drawings and the attached claims.

### DETAILED DESCRIPTION

The method and system herein provides for non-traditional address translation. The system uses a software interface with one or more databases that connect and translate a specific building name, the building's area name, and room/door number as recognized the occupant. Based on user input, the user submits the non-traditional address, which is translated into a delivery location identifier. In one embodiment, the delivery location identifier can include: (1) geolocation data; and (2) other information.

The address translation system integrates or communicates with a delivery system or portal. The delivery system receives the delivery location identifier and modifies the delivery instructions based thereon. Whereby the user is able to receive a delivery to his or her non-traditional address from delivery networks using standard delivery systems or portals.

The address translation system includes one or more databases that connect a specific building name, the building's area name, and room/door number, as recognized by the occupants, with a verified geolocation of the building. The address translation system can be generated by verifying the actual location of the building and area nomenclature used by the resident, as well as verifying the exact geolocation.

One exemplary embodiment is an on-demand delivery to a barracks on a military base. For example, Camp Lejeune Marine Corps base, Building HP500, Room 250, latitude XXXXXX, longitude YYYYYY. This exact location is verified by the known nomenclature and verified geolocation data. This information is uploaded to an online database. When the occupant at Building HP500, Room 250 places an online delivery order, the occupant can access the address translation system for entering this non-standard address information.

As described in greater detail below, one embodiment may include a user interface, whereby the user selects: (a) the general geographic area (Camp Lejeune); (b) the building (HP500); and (c) additional information such as the room number (Room 250).

The address translation system therefore translates this input into information usable for delivery, for example the geolocation data and any additional identifier information, e.g. building name and room number. This geolocation data and additional information is then integrated into the delivery platform for facilitating delivery.

A second example is an overnight package delivery. The user can access the user interface for submitting the non-traditional address information concurrent with the item ordering. The commercial carrier delivering the package can then supplement delivery instructions with the geolocation data and the additional information.

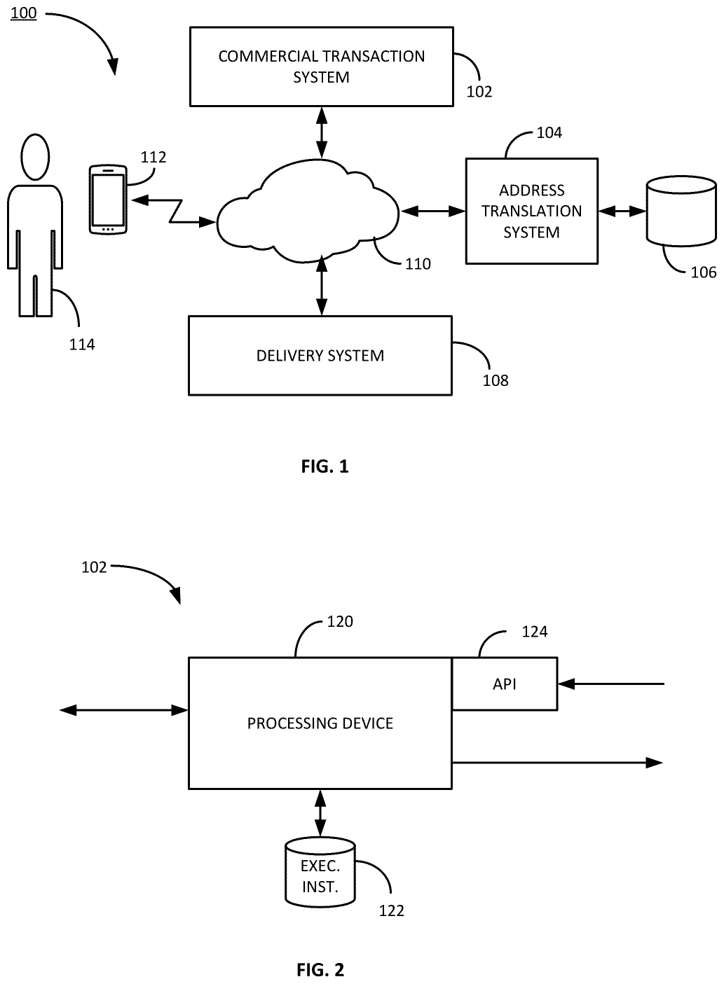

FIG. 1 illustrates one embodiment of a processing system 100 for supplementing a commercial transaction accounting for a consumer or recipient having a non-postal address. The system 100 includes a commercial transaction system 102, an address translation system 104, a geolocation database 106, a delivery system 108. The system includes communication across a network 110 and interacts via a mobile computing device 112 executed by a user 114.

As used herein, a non-postal address may be any address or location not expressly categorized, noted, or maintained within a standardized address management system. In a preferred embodiment, the address management system data is data managed by the United States Postal Service (USPS). This address management system data tracks all recognized postal addresses in areas covered by the USPS. This data serves as the basis for mapping software and navigation software, allowing for generation and distribution of navigational instructions for finding a specific location.

In one embodiment, the non-postal address may be a physical location disposed on a location managed by the United States Department of Defense (DOD). For example, the physical location may be disposed on a military installation or base managed by the DOD. For example, one location may be a barrack used to house military personal. It is recognized that where a DOD location itself can be recognized and cataloged within the standard address management system, locations within the DOD location are not and thus addresses within DOD locations are non-postal addresses.

The commercial transaction system 102 may be any suitable software processing system for facilitating a commercial transaction, having additional processing capabilities as noted herein.

For example, one embodiment of a commercial transaction system can be a food or grocery ordering software system. The commercial transaction system can include menus or other datasets of items available for purchase and allow the user to engage in standard commercial transactions of selecting item(s) for purchase. The commercial transaction system 102 includes additional processing elements facilitating the supplementation as noted herein. The above examples of food or groceries are general examples and are not expressly limiting in nature, where the commercial transaction system 102 can provide for any suitable type of commercial transaction.

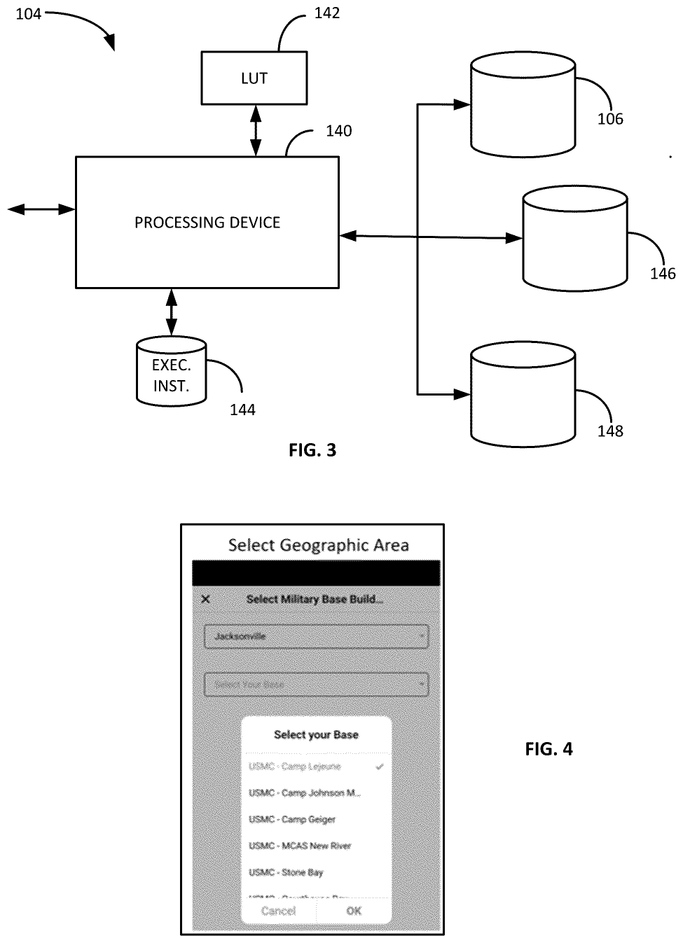

FIG. 2 illustrates one exemplary embodiment of the commercial transaction system 102. This system 102 includes a processing device 120 and executable instructions 122. Additionally, the system 102 includes an address translation module 124, for example one embodiment being an application program interface (API). The API 124 facilitates additional functionality for the processing device 102, in addition to the executable instructions 122.

In reference back to FIG. 1, the commercial transaction system 102 can communicate with the address translation system 104 via the network 110. The network 110 can be any suitable network or combination of networks, including for example but not limited to the Internet, an intranet, etc. As recognized by a skilled artisan, communication between system 102 and 104 may include communication protocols, encryption, and other network administrative elements.

FIG. 3 illustrates one embodiment of the address translation system 104. This embodiment may be disposed in a network processing environment, for example in a cloud-based application system. In one embodiment, system 104 may be disposed within or integrated within a commercial transaction system (102 of FIG. 1) and is not expressly required to be a separate processing system. In one embodiment, system 104 may be disposed within the delivery system 108 of FIG. 1.

The address translation system 104 includes one or more processing devices 140 and may include in one embodiment a look-up table 142. The system 104 includes at least non-transitory memory device having executable instructions stored therein, the processing device performing processing operations in accordance with the executable instructions. The look up table 142 may be a reference dataset relating to interfacing with the commercial transaction system as described in greater detail below.

In further embodiments, the device 140 accesses any number of databases 106, 146, and 148. The databases can include varying forms of geolocation identifier information. For example, dataset 106 may include global positioning information. For example, dataset 146 may include text-based location instructions or other text information associated with a location. For example, dataset 148 may include images of one or more locations.

In FIG. 1, the delivery system 108 may be any suitable software application providing delivery of ordered item(s).

In one embodiment, the delivery system 108 may be part of the commercial transaction system 102 where the system 102 provides for delivery as part of the service. For example, a food company that makes pizzas may include drivers that deliver pizzas, therefore where the users order pizzas in the commercial transaction system, the same pizza company may also provide the delivery system 108.

In one embodiment, the delivery system 108 may be a third party service provider that compliments the commercial transaction system 102. For example, a first vendor may sell groceries and other items, but a second vendor delivers the orders. In this embodiment, the system 102 and 108 may be separate processing systems.

In one embodiment, the delivery system 108 may be the user interface or portal application facilitating the commercial transaction and providing the commercial transaction system 102. For example, a delivery vendor may have numerous drivers available to deliver items, but also provides a software application allowing users to select from a number of possible restaurants (or other vendors), order food (or other items) via the delivery vendor application. In this embodiment, the system 102 and 108 can both be within the same processing system.

The processing device 112 may be any suitable computing device capable of interacting with applications or other software. For example, the device 112 may be a mobile phone running an “app” allowing the user 114 to place an order for delivery. For example, the device 112 may be a laptop or desktop computer for the user 114 to run a browser application and order via a web location.

FIGS. 4-6 illustrate sample screenshots of user interfacing operations associated with supplementing a commercial transaction. These screenshots represent sample interface options available for a user while executing the commercial transaction. For example, the user can launch an app to order food from a local restaurant, the app including a button to select if the user seeks delivery to a non-postal address.

If selected, FIG. 4 illustrates a first pull-down menu screen for the user to select a geographic area, and then listing military bases. Here, the user can select his or her military base.

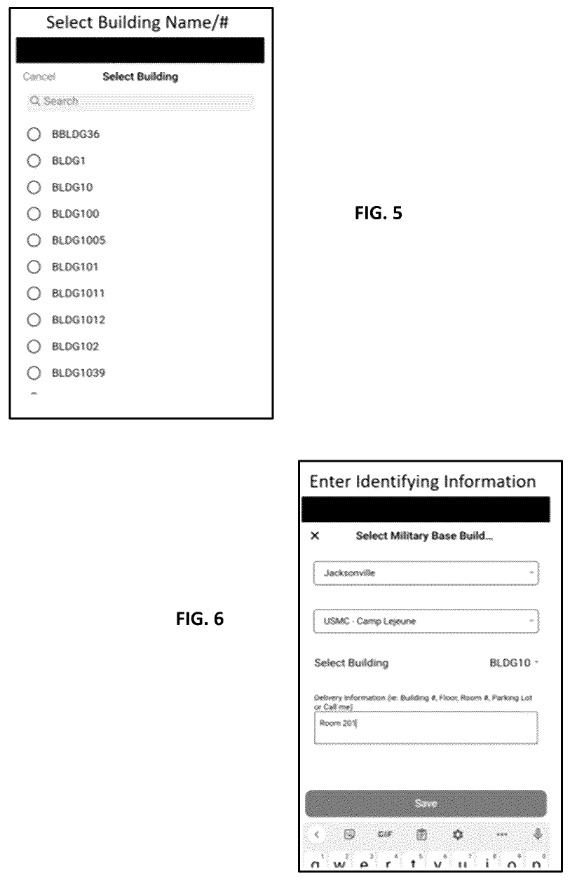

Populated data fields within the app can include sub-levels of information for buildings within the various military bases. FIG. 5 illustrates a sample next screen from the user in FIG. 4 selecting Camp Lejuene. In FIG. 5 the user is presented with available buildings. The user can select a corresponding radio button for the building number.

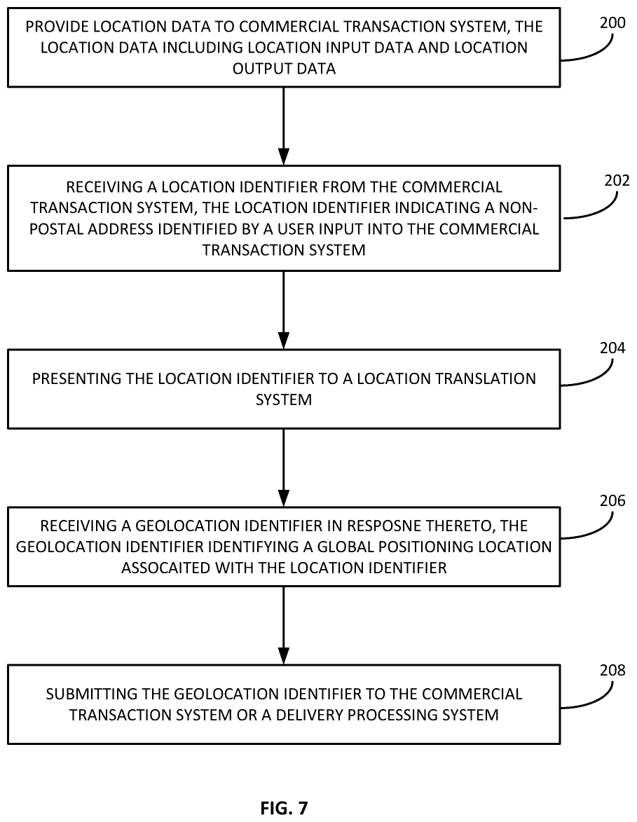

FIG. 6 illustrates a sample screenshot following FIG. 5, where the user selected BLDG10. In this embodiment, the user is presented with an additional question of a room number. Here, the user can be presented with additional pull-down menus or this exemplary embodiment allows the user to type in a particular room number.

Where FIGS. 1-3 illustrate processing system embodiments and FIGS. 4-6 illustrate sample screenshots, FIG. 7 illustrates a flowchart of the steps of one embodiment of a method for supplementing a commercial transaction. Step 200 is providing location data to a commercial transaction system, the location data includes location input data and location output data for use by the commercial transaction system.

For example, in FIG. 1, the system 104 may provide this data to the system 102. The location data includes data usable by the processing device 120 via the API 124 (FIG. 2). This location data includes input data in the form of data usable by the processing device 120 (FIG. 2) for supplementing the user interface. For example, as noted in FIGS. 4-5 screenshots, the input data can include the listing of bases, or other locations having non-postal addresses, and buildings located thereon. Where the input data is data usable by the commercial transaction system 102 within the user interfacing, the output data is data capable of being sent back to the address translation system 104. In some embodiments, the output data may be the same as the input data, e.g. a listing of locations and buildings.

In other embodiments, the output data may be one or more data fields or identifiers associated with a particular location but usable by the address translation system for later processing. For example, if the input data is a listing of military bases and buildings on the base, the output data may be data strings representing a selected base and building. The output data may also include a data field or fields for manually entered information, for example the user manually typing in a room number.

Step 202 is receiving a location identifier from commercial transaction system. The location identifier indicates a non-postal address identified by a user input into the commercial transaction system. In one embodiment, the location identifier may include the location output data or a variation of or reference to the location output data.

In between steps 200 and 202, the user engages the commercial transaction system for conducting a commercial transaction. For example, the user may order food, groceries, or any other item and the commercial transaction includes user interface software allowing the user to indicate the non-postal address, e.g. FIGS. 4-6.

The commercial transaction system conducts processing operations for the commercial transaction, and uses the address translation system for the non-postal address. In the address translation system, step 204 is presenting the location identifier to a location translation system. The location translation system may be a processing module within the processing device 140 of FIG. 3, providing for data lookup and/or data translation operations.

In one embodiment, the location translation system can use the location identifier as a search or data retrieval function from a database, such as database 106 of FIG. 3. For example, if the location identifier is a data field indicating a location (military base); name of building (barrack); room number, this data field can be used as a data search input string.

In another example, the location output data of step 200 may include data for generating a data string, such as a hash value or other string. For example, location names may be assigned a first set of values and buildings may be assigned a second set of values, the data string being a combination of the values. Therein the location identifier can be the data string, the processing device may access a lookup table to correspond the data string with a search value. The search value is usable for searching and retrieving geolocation information.

Step 206 is receiving a geolocation identifier in response to the search request. The geolocation identifier identifies a global position location associated with the location identifier. For example, one embodiment of global position location may be longitudinal and latitudinal values.

In further embodiments, the geolocation identifier may include additional or complimentary data. For example, data may include written instructions or other information associated with finding the location such as notation of landmarks, designation of one-way streets or travel restrictions, etc. Other information may include images, such as photographs of the building, driveways, designated parking locations, etc.

Step 208 is submitting the geolocation identifier to the commercial transaction system or a delivery processing system. For example, the geolocation identifier can be transmitted to the commercial transaction system, where the geolocation identifier replaces the standard postal address information. For example, a delivery platform may receive the geolocation identifier to compliment delivery instructions or other information from the commercial transaction system.

In further embodiments, the geolocation identifier may include additional data fields for text or other user-submitted information. In the FIG. 6 screenshot, the user manually enters a room number. This data entry can be captured and added as the data field. In another embodiment, original content recognition (OCR) or other data processing operations may be utilized to recognize and translate the user data entry. For example, OCR software may process the FIG. 6 enter of “room 301” and insert “301” or “room 301” as part of the geolocation identifier or as part of complimentary data associated with the geolocation identifier.

Therein, the methodology of FIG. 7 provides for complimenting the commercial transaction by allowing transactions and delivery of non-postal addresses.

Further embodiments can provide for additional techniques for collecting information associated with the geolocation identifier. These examples can include user-generated content by one or more users manually inserting information into the databases 106, 146, 148 of FIG. 3. For example, someone may manually walk around and collect and record GPS coordinates. For example, someone may take pictures of buildings, landmarks, and other features for supplementing the GPS information. For example, someone may be manually enter text or other instructions for complimenting delivery or finding a location, e.g. designating a parking location, noting nearby traffic concerns such as restricted areas and one-way streets, etc.

For example, using the example noted above, the identifying information can be Building HP500 and Room 250. The identifying information can also include notes that the building is between buildings HP300 and HP700 and there is a specific landmark across the street.

The identifying information may be user-generated. The identifying information could also be generated by delivery drivers, supplementing the information with content germane to his or her delivery experiences.

In one embodiment, the database content usable by the address translator is generated by physical inspection and data entry associated with the non-traditional addresses. In this embodiment, one or more content creators can physically walk around the location, tracking geolocation information associated with specific buildings and rooms.

Creating this content can include a geolocation acquisition function with associated identifying information fields. For example, while operating on a mobile device, an application can record the geolocation data and use data input fields for receipt of the identifying information. Information could also include photographs.

The present method and system may utilize any number of available techniques for building or maintaining the one or more databases with verified geolocation. For example, one embodiment may include accessing pre-existing mapping data, such as available from the Department of Defense for military bases or other pre-existing data sets. In another example, data can be collected using drones or other mobile devices with a GPS location identifier and/or cameras.

The database content may be supplemented with iterative usage by various users. The database content can also be supplemented by feedback from one or more delivery drivers.

In further embodiments, geolocation data can be secured or encrypted data. For example, where security concerns arise, geolocation information may be restricted to secure communication devices or limited distribution across delivery or commercial transaction platforms.

Therefore, the present method and system overcomes delivery limitations associated with non-postal addresses. The method and system, integrated within commercial transaction software, supplements commercial transactions and/or delivery instructions by generating the geolocation information for non-postal addresses.

FIGS. 1 through 7 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. A computerized method for supplementing a commercial transaction, the computerized method comprising:
providing location data to a commercial transaction system, the location data including location input data and location output data for use by the commercial transaction system;
receiving a location identifier from the commercial transaction system, the location identifier indicating a non-postal address identified by a user input into the commercial transaction system based at least on the location input data and the location output data;
presenting the location identifier to a location translation system;
receiving a geolocation identifier in response thereto, the geolocation identifier identifying a global positioning location associated with the location identifier; and
submitting the geolocation identifier to the commercial transaction system.

2. The computerized method of claim 1, wherein the geolocation identifier includes a latitude value and a longitudinal value.

3. The computerized method of claim 2, wherein the geolocation identifier includes text-based location instructions associated with the geolocation identifier.

4. The computerized method of claim 2, wherein the geolocation identifier includes visual data associated with the geolocation identifier.

5. The computerized method of claim 1, wherein the non-postal address includes a physical location not categorized by address management system data maintained by the United States Postal Service.

6. The computerized method of claim 1, wherein the non-postal address includes a physical location disposed on a location managed by the United States Department of Defense.

7. The computerized method of claim 6, wherein the non-postal address identifies a name of a barrack.

8. The computerized method of claim 7, wherein the non-postal address identifies a room number within the barrack.

9. The computerized method of claim 1, wherein the geolocation identifier is in a computer format usable by the commercial transaction system for coordinating delivery of at least one item as part of a commercial transaction wherein the location data was previously received by the commercial transaction system.

10. A computerized method for supplementing a commercial transaction, the computerized method comprising:
providing location data to a commercial transaction system, the location data including location input data and location output data for use by the commercial transaction system, wherein the location data is received by the commercial transaction system as part of a commercial transaction for purchasing a first item;
receiving a location identifier from the commercial transaction system, the location identifier indicating a non-postal address identified by a user input into the commercial transaction system based at least on the location input data and the location output data;
presenting the location identifier to a location translation system;
receiving a geolocation identifier in response thereto, the geolocation identifier identifying a global positioning location associated with the location identifier; and
transmitting the geolocation identifier to a delivery transportation system for delivery of the first item.

11. The computerized method of claim 10, wherein the geolocation identifier includes a latitude value and a longitudinal value.

12. The computerized method of claim 11, wherein the geolocation identifier includes text-based location instructions associated with the geolocation identifier.

13. The computerized method of claim 11, wherein the geolocation identifier includes visual data associated with the geolocation identifier.

14. The computerized method of claim 10, wherein the non-postal address includes a physical location not categorized by address management system data maintained by the United States Postal Service.

15. The computerized method of claim 10, wherein the non-postal address includes a physical location disposed on a location managed by the United States Department of Defense.

16. The computerized method of claim 15, wherein the non-postal address identifies a name of a barrack.

17. The computerized method of claim 16, wherein the non-postal address identifies a room number within the barrack.

18. A processing system for supplementing a commercial transaction, the system comprising:
at least one computer-readable medium having executable instructions stored therein; and
at least one processing device, in response to the executable instructions, operative to:
provide location data to a commercial transaction system, the location data including location input data and location output data for use by the commercial transaction system;
receive a location identifier from the commercial transaction system, the location identifier indicating a non-postal address identified by a user input into the commercial transaction system based at least on the location input data and the location output data;
present the location identifier to a location translation system;
receive a geolocation identifier in response thereto, the geolocation identifier identifying a global positioning location associated with the location identifier; and
submit the geolocation identifier to at least one of: the commercial transaction system or a content delivery system.

19. The system of claim 18, wherein the geolocation identifier includes at least one of: a latitude value and a longitudinal value; text-based location instructions; and visual data.

20. The system of claim 18, wherein the non-postal address includes at least one of: (a) a physical location not categorized by address management system data maintained by the United States Postal Service, or (b) a physical location disposed on a location managed by the United States Department of Defense.
